(19) United States
(12) Patent Application Publication
(10) Pub. No.: US 2008/0235954 A1
(43) Pub. Date: Oct. 2, 2008

(54) Utility Knife

(76) Inventor: Patrick J. Radle, Mequon, WI (US)

Correspondence Address: QUARLES & BRADY LLP, 411 E. WISCONSIN AVENUE, SUITE 2040, MILWAUKEE, WI, 53202-4497, US

(21) Appl. No.: 12/058,192

(22) Filed: Mar. 28, 2008

Related U.S. Application Data
(60) Provisional application No. 60/908,875, filed on Mar. 29, 2007.
(60) Provisional application No. 60/951,106, filed on Jul. 20, 2007.

(51) Int. Cl. B26B 3/06

(52) U.S. Cl. 30/152

(57) ABSTRACT

A hand tool with a cable jacket ripper in a housing of the tool is provided. The cable jacket ripper includes an opening with a blade presenting a cutting edge. Rotating the housing relative to a cable engages the blade with the jacket of the cable to pierce the jacket. Thereafter, the cable may be slit longitudinally by the hand tool and the blade. The hand tool may be a utility knife with a cutting blade positioned at an end of the utility knife opposite the cable jacket ripper.

### CROSS-REFERENCE TO RELATED APPLICATION

This application claims the benefit of U.S. Provisional Patent Application No. 60/908,875 filed Mar. 29, 2007 and of U.S. Provisional Patent Application No. 60/951,106 filed Jul. 20, 2007, which are hereby incorporated by reference.

### STATEMENT CONCERNING FEDERALLY SPONSORED RESEARCH OR DEVELOPMENT

Not applicable.

### FIELD OF THE INVENTION

This invention relates to tools for doing electrical work, and in particular to a utility knife adapted for electrical work.

### BACKGROUND OF THE INVENTION

Retractable blade utility knives are in common usage, and there are many patents covering such knives. One such patent is U.S. Pat. No. 3,872,591. This patent discloses a retractable blade utility knife that can use a standard blade and has a button in the side of the housing that when pressed when the blade is in the forward-most position releases the blade from the blade carriage. This patent also discloses a drop-down storage compartment for storage of extra blades that is pivoted to the housing of the knife and can be pivoted up into the housing of the knife during use.

These are desirable features in a utility knife and are incorporated, albeit differently, in the present preferred embodiment. Prior utility knives, however, were for general purpose cutting, typically of materials Like cardboard or carpeting, or other materials where a relatively rigid, sharp, razorblade-type edge could be used.

In the electrical field, a utility knife is also a useful tool for opening boxes, slitting plastic jackets of wires, and other uses. Electricians must carry around many different tools that are specialized for doing electrical work. There is a need in the art for a utility knife that is specially adapted for electrical work.

### SUMMARY OF THE INVENTION

In one aspect, the invention provides a combination utility knife and electrical detector that is incorporated into the housing of the utility knife and removable therefrom. In the preferred embodiment, the detector is a non-contact AC voltage detector.

In addition, preferably, in one aspect of the invention, the knife is configured to also include a wire jacket ripper that can be used for longitudinally ripping open the plastic insulating jackets of wires, such as non-metallic sheathed electrical cables, which are a multi-conductor wire with multiple conductors included in an non-round jacket that contains the wires in generally side-by-side relationship. At least some of the wires inside the jacket are typically insulated.

In a preferred form, the ripper included in the preferred embodiment of the knife disclosed herein has an opening in the housing for receiving a cable extending axially through the opening. The opening has a blade presenting a cutting edge oriented axially in the opening on at least one side of the cable inserted through the opening, and positioned in the opening so that it can be brought into cutting contact with a jacket of the cable to slit the jacket longitudinally.

Preferably, the opening and the jacket received in the opening are non-round so that rotating the cable against the opening engages the blade with the jacket, and then the cable can be pulled out of the opening to slit the jacket.

In another preferred aspect, the blade in the ripper opening is W-shaped to present a corner at each end of the blade. The cutting edge at either corner can be used to slit the jacket, so that ripper can be used in either direction.

As mentioned above, the cable will typically be what is known as non-metallic sheathed electrical cable, or simply NM cable, which is a generally oblong wire having a plastic jacket that envelopes multiple insulated wires.

Preferably, the knife has a housing that is predominantly plastic, and may have portions that are overmolded with a rubber skin for a better feel and grip. Plastic provides an insulating material that is electrically insulating. Critical areas of the housing can be reinforced with metal. In addition, a heavy metal insert is preferably used inside the plastic housing that provides a guideway for the blade carrier and defines the stop positions whereat the blade stops upon depressing the thumb button that moves the blade. The heavy metal weight also gives the knife a more heavy duty feel.

Preferably, the housing of the knife defines a pocket that receives the detector module in a manner such that it is snapped or detented into position securely and to be removed must be intentionally removed, i.e., it will not fall out by itself. In addition, the detector preferably has a switch that is accessible when the detector is in the pocket of the tool and has the sensor end of the detector at an exposed end of the pocket. In addition, the detector preferably has a visual indicator which is visible while the detector is in the pocket so that the detector can be turned on while it is in the pocket and used to detect, for example, a voltage, and that can be perceived by the user while the detector is in the pocket of the tool. The detector is also preferably removable from the pocket so that it can be used by itself, or used in conjunction with other tools that have similar pockets. Similarly, if the detector becomes non-functional or a different type of detector, for example a stud detector, is desired, that type of detector can be configured similarly to interface with the housing of the knife and used in place of the original detector.

The foregoing and other objects and advantages of the invention will appear in the detailed description which follows. In the description, reference is made to the accompanying drawings which illustrate a preferred embodiment of the invention.

### BRIEF DESCRIPTION OF THE DRAWINGS

FIG. 1 is a perspective view of a utility knife incorporated in the invention;

FIG. 2 is a perspective view of the knife from the rear with the detector module removed;

FIG. 3 is an exploded view of the knife;

FIG. 4 is an exploded view like FIG. 3, but from the other side;

FIG. 5 is a left side view with one side of the knife housing removed, and also showing the blade removal button in position and with the blade extended;

FIG. 6 is a cross-sectional fragmentary view from the plane of the line 6-6 of FIG. 5;

FIG. 7 is a view like FIG. 5, but with the blade storage compartment pivoted down and the blade retracted;

FIG. 8 is a view with the right side of the housing removed, unlike FIGS. 5 and 7 in which the left side of the housing is removed, and showing the detent holding the detector module in place and a lanyard attached to the module;

FIG. 9 is a fragmentary cross-sectional view from the plane of the line 9-9 of FIG. 8;

FIG. 10 is a view like FIG. 8 but with the right side housing half present;

FIG. 11 is a fragmentary side view showing a piece of non-metallic sheathed electrical cable (NM) positioned in the ripper opening ready to be ripped;

FIG. 12 is a cross-sectional view from the plane of the line 12-12 of FIG. 11, without the NM cable in position;

FIG. 12a is a view like FIG. 12 showing the NM cable in the ripper opening, but not engaged with the ripper blade;

FIG. 12b is a view like FIG. 12a but with the knife tipped to engage one corner of the blade with the NM cable jacket;

FIG. 12c is a view like FIG. 12b but showing the NM cable pulled through the ripper opening;

FIG. 12d is a view showing use of the extended blade to cut off the excess ripped open NM cable jacket;

FIG. 13 is a view showing the initial step of using the wire stripper feature of the utility knife, with an insulated wire ready to be stripped;

FIG. 14a shows the wire in the wire stripper opening of the knife;

FIG. 14b shows the wire positioned so as to cut through the insulation of the wire with the blade, down to the metal wire;

FIG. 14c illustrates rotation of the knife about the wire to make a circular cut around the insulation;

FIG. 15 shows the end of the wire with the insulation removed;

FIG. 16 is a cross-sectional view from the plane of the line 16-16 of FIG. 5;

FIG. 17 is a view like FIG. 16 but with the blade release button depressed;

FIG. 18 is a perspective view of the blade carrier of the knife; and

FIG. 19 is a perspective view of the stop piece of the knife.

### DETAILED DESCRIPTION OF THE PREFERRED EMBODIMENT

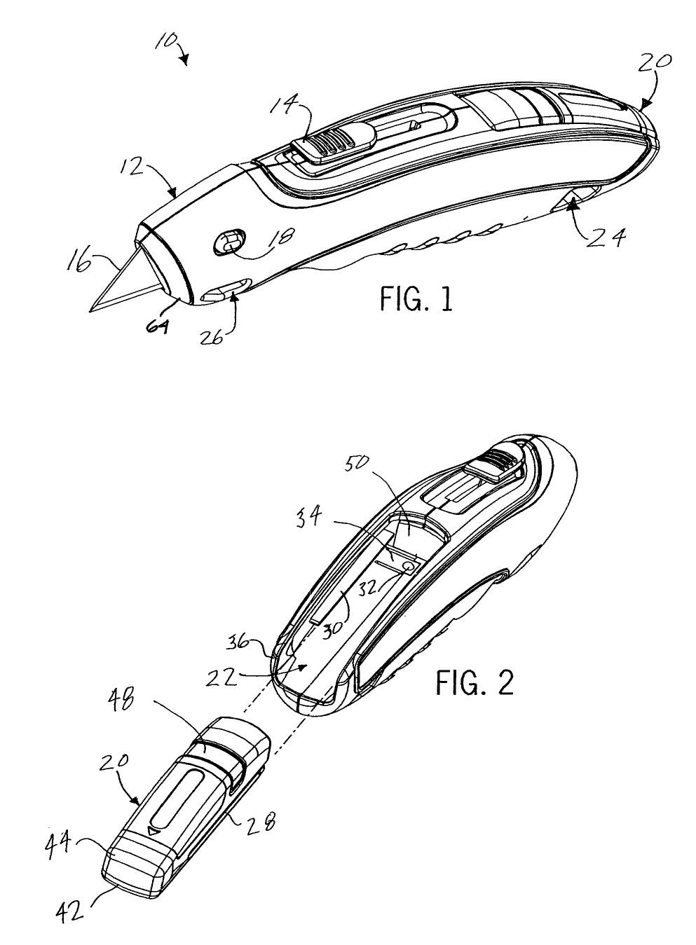

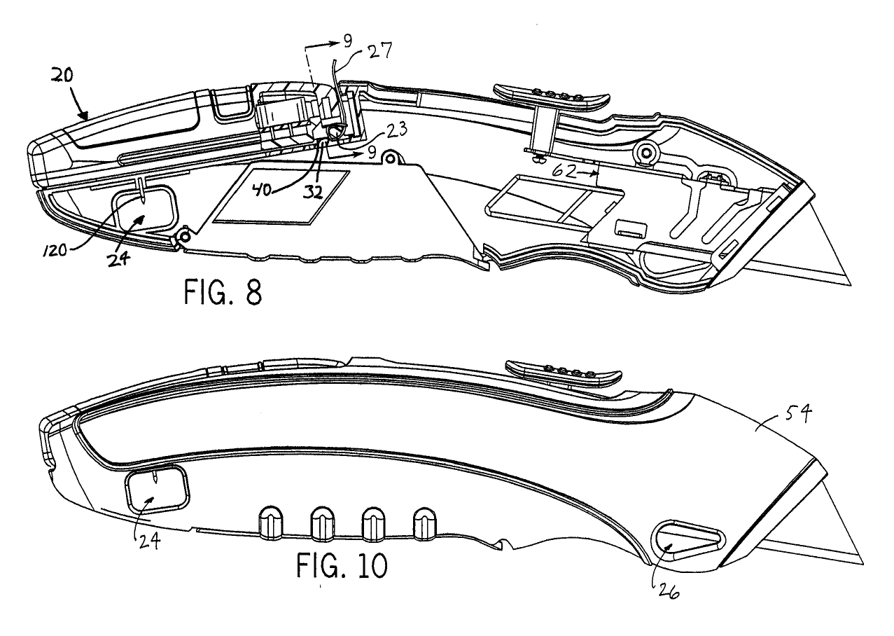

Referring to FIG. 1, a knife 10 of the invention has a housing 12, a slideable blade actuator button 14, a removable blade 16 that is extended and retracted by operation of the button 14, a blade release button 18, a detector module 20 received in a detector module pocket 22 at the rear end of the knife housing 12, an insulation ripper 24, and a wire stripper 26. As seen in FIG. 2, the detector module housing 20 has longitudinal slots 28 formed in it, at the sidewalls near the bottom of the housing, that receive and are guided by ribs 30 on opposite sides of the pocket 22. A detent button 32 is molded at the end of a leaf spring 34 of the left housing half 36 that snaps or detents into a hole 40 (FIG. 8) in the bottom of the detector module 20 to hold the detector module 20 in the pocket 22.

The detector module 20 is described in PCT Publication No. WO 2008/011517 (which is hereby incorporated by reference; module 20 is the same as module 200 in PCT Publication No. WO 2008/011517). The detector module may be any kind of detector, for example a non-contact AC voltage detector. Preferably, the sensor end of the module is at the rear end 42 of the module, which is at the rear end of the knife 10 when the module is inserted into the pocket. Also at end 42 is a translucent portion of the detector housing 44 such that a light is inside that portion that is visible to provide a visual indication of what is being detected to the user, for example live AC voltage. Also preferably, a switch 48 part of the detector housing is accessible by a user when the detector module 20 is received in the pocket 22. The switch 48 is preferably a three-way switch, meaning that it can be pressed (actuated) either from the top or from either side of the module 20. In addition, referring to FIG. 8, the hole 40 in which the detent button 32 is received extends through the detector housing 20 and exits out the front end of the housing to create a bridge 23 of material to which a lanyard 27 can be attached. Referring again to FIG. 2, in addition, preferably, a rubber bumper 50 is provided at the forward end of the pocket 22 so that if the knife is dropped on its end, the rubber absorbs the impact of the module 20 being pushed further into the pocket 22. Preferably, the detector 20 also provides an audible indication to a user when a live AC voltage is detected.

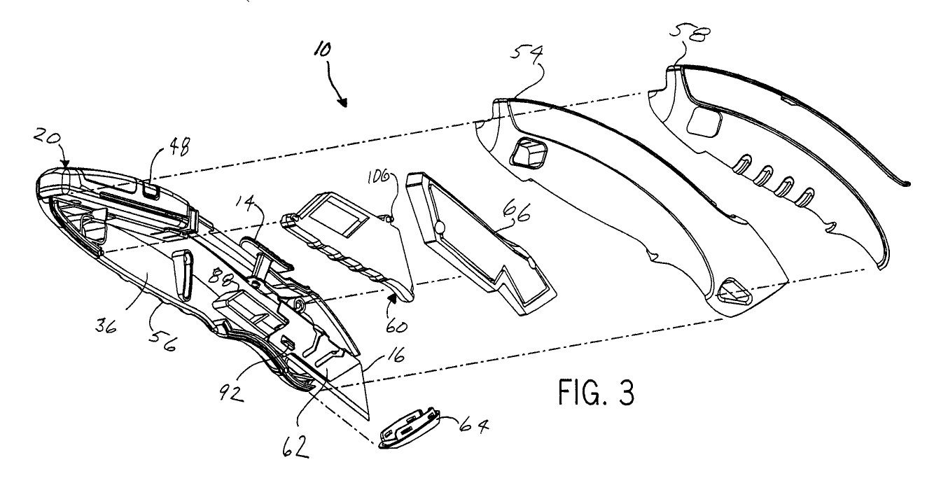

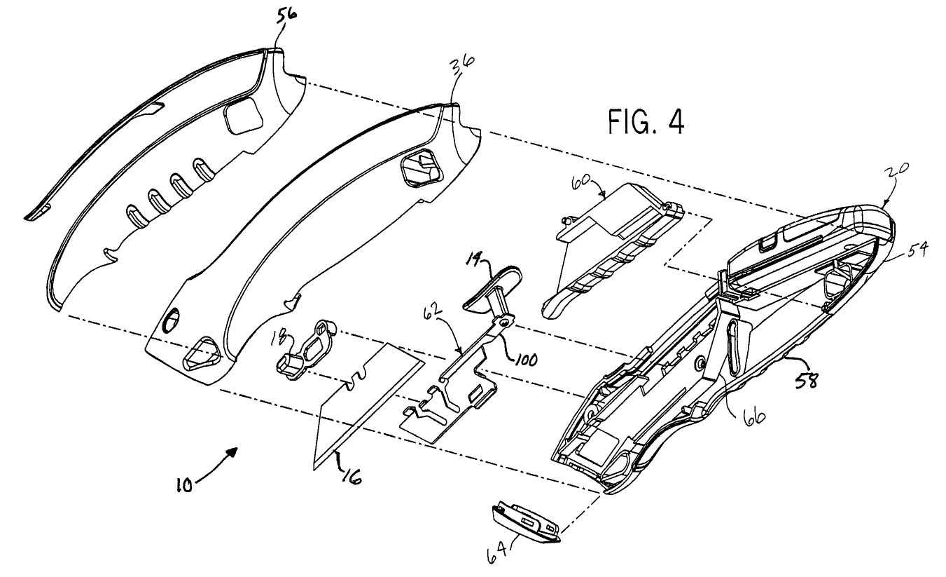

Referring to FIGS. 3 and 4, the housing 12 is made in two halves, a left housing half 36 and a right housing half 54. The housings are preferably an impact-resistant molded plastic, for example, impact resistant ABS. Also, each housing half preferably includes an overmolded rubber or elastomeric layer 56 and 58 at the portions of the housing that come into the most contact with the user's hands. The hard plastic of the knife is preferably of one color, and the elastomeric overmolding is preferably of a different color to provide an aesthetically pleasing design. In addition, the button 14 can be made the same color as the elastomer, and the blade storage compartment 60 door can be made the same color and shape as the elastomer to the sides of the door if desired. It is noted that the lower part of the elastomeric overmolding has ribs to conform to a user's fingers, and that those ribs are also formed in the door part of the blade storage compartment 60.

Still referring to FIG. 3, the knife 10 also includes a blade carrier 62 that is made out of sheet metal and attaches to the button 14 which is molded plastic, a one-piece metal nose 64 that surrounds the blade when the blade is extended, and a guide and stop piece 66 which is preferably made of metal or another relatively hard and dense material to give the knife a good weighty and heavy-duty tactile feel. The stop piece 66 preferably provides at least half of the weight of the knife 10.

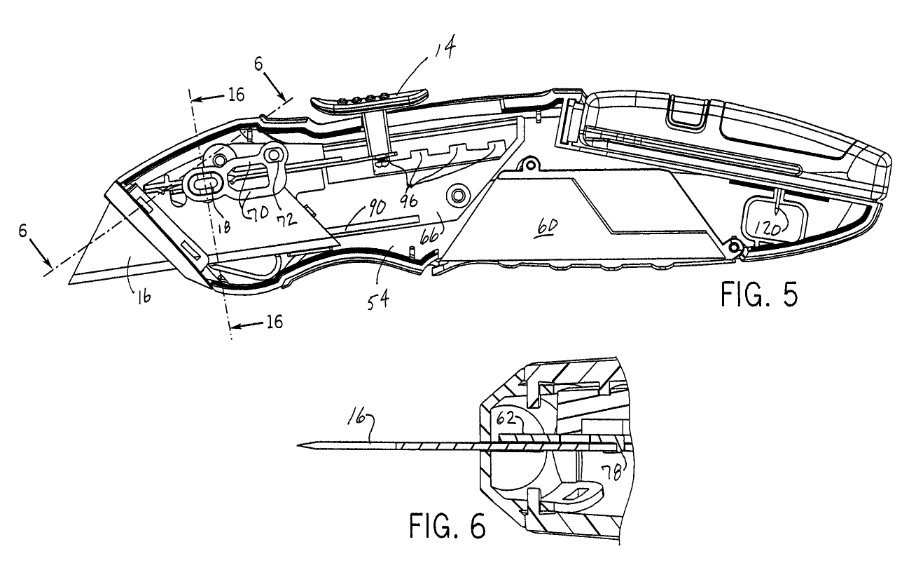

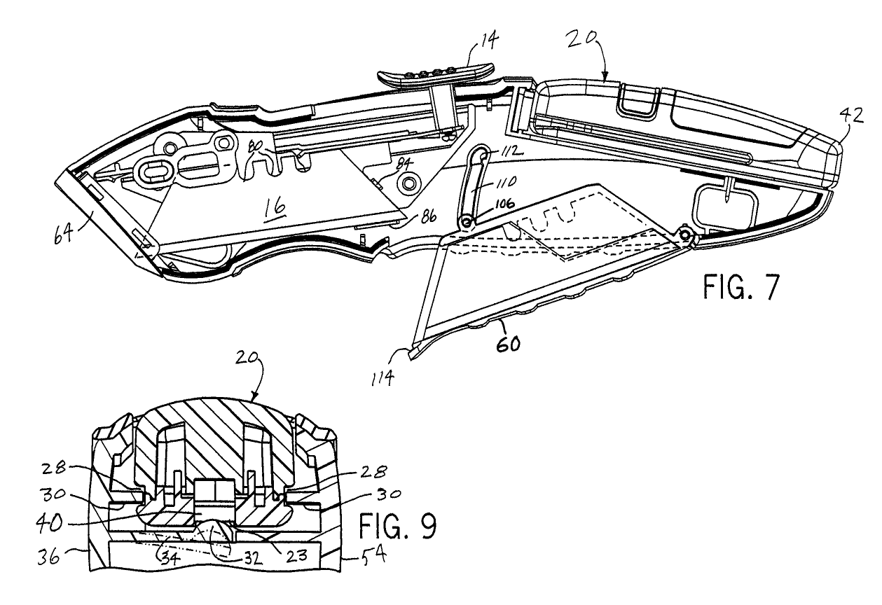

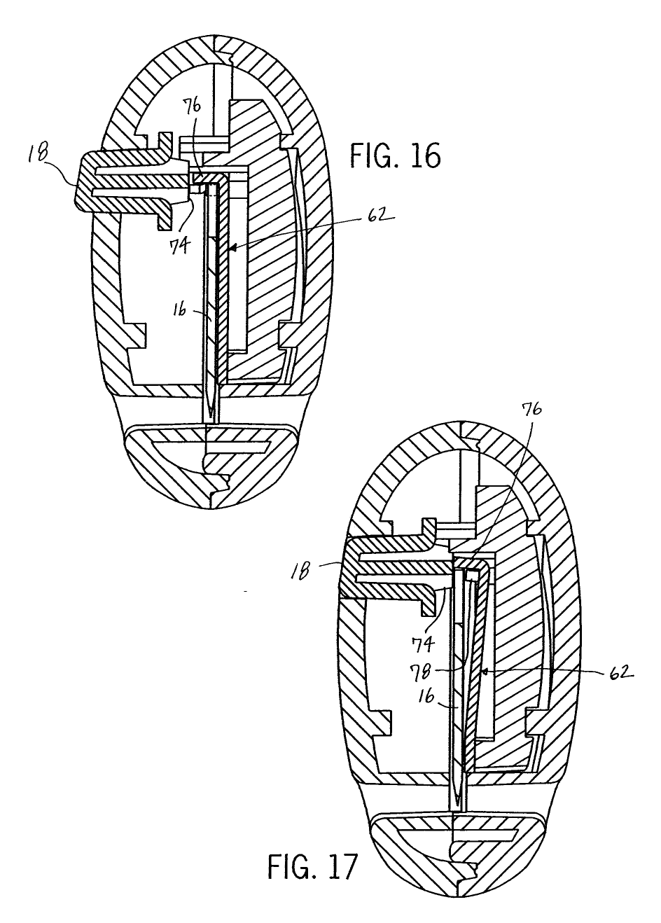

The two housing halves 36 and 54 are assembled together and held together by ultrasonic welding, adhesive, or any other suitable means. Once put together, it is intended that the housing need never be taken apart, as is usually the case with conventional utility knives. Instead, the blade release button 18 can be pushed when the blade is in the extended position to release the blade from the blade carrier 62. Referring to FIG. 5, the blade release button 18 is supported by leaf spring portions 70 that are integrally molded with the button 18 and also integrally molded at the opposite end with a mounting portion 72. The mounting portion 72 is secured to the left housing half 36, for example, with a screw. Referring to FIGS. 16 and 17, when the button 18 is depressed, an extension 74 of the button presses on a tab 76 of the blade carrier 62 (FIG. 17) to release ear 78 from one of the conventional top slots 80 (FIG. 7) of the blade 16 that captures the blade 16 in the carrier 62. Referring to FIG. 7, in conventional fashion, the ear 78 extends into one of the top slots 80 to hold the rear corner of the blade in the corner defined by the tabs 84, 86 of the carrier 62. This, in combination with a limited space defined between the weight 66 and rib structure 88 (FIG. 5) on left housing half 36, captures the blade 16 in the carrier 62.

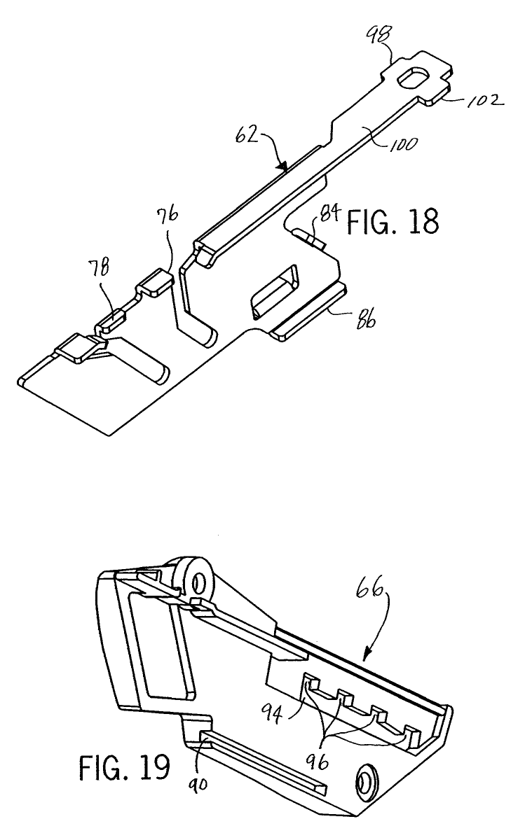

Referring to FIGS. 5 and 19, weight 66 also has a slot 90 in which tab 92 (FIG. 3) of carrier 62 slides for additional guidance and has a recess 94 that has a castellated upper wall that defines four stop recesses 96 for the tab 98 (FIG. 18) at the rear of the spring arm 100 of the carrier 62 to enter, to define stop positions for the extension of the blade 16. Tab 102 (FIG. 18) extends from the opposite side of the spring arm 100 to be guided by suitably shaped lands or other structure extending from the left housing half 36 toward the right housing half 54 to help keep the tab 98 engaged in the stop recesses 96. Referring to FIG. 4, weight 66 is held to the right housing half 54 by any suitable fasteners (e.g., screws) or adhesive. Button 14 has a downwardly extending leg that is secured to the spring arm 100 by a fastener such as a screw extending through the hole at the rear end of the spring arm 100. To release the carrier 62 from a stop position, the button 14 is depressed, which moves the tab 98 downwardly out of which ever stop recess 96 it is nested in.

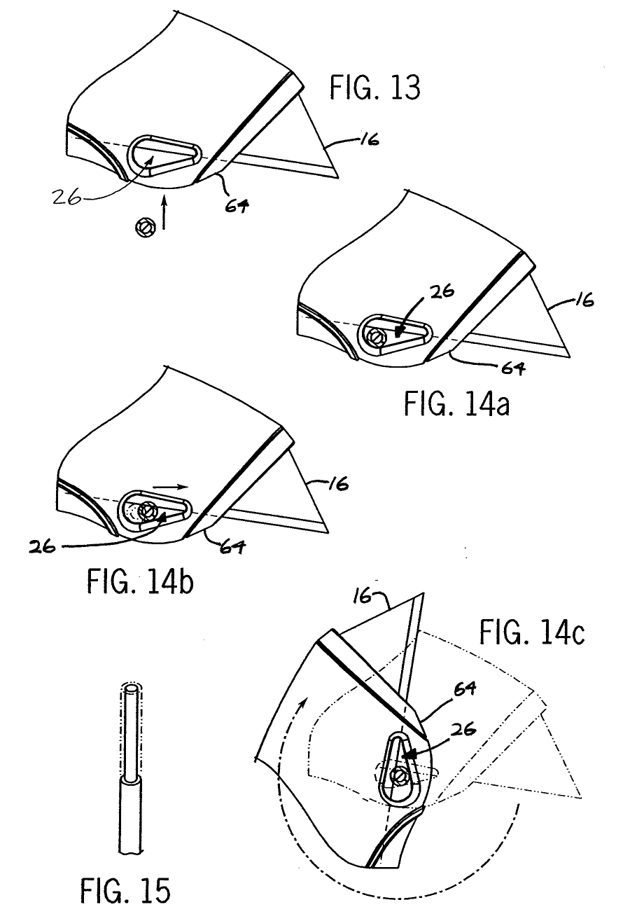

The nose 64 is preferably metal and defines a slot through it which is just slightly larger than the thickness of the blade 16 and so that the blade 16 is surrounded by the metal of the nose 64. The nose 64 is trapped between the housing halves 36 and 54 by having a flange extending rearwardly from the nose 64, shown in FIGS. 3 and 4, into the housing halves and slots formed in the flange, with tabs of the housing halves fitting in the slots to secure the nose 64 relative to the plastic housing halves. Referring to FIGS. 1, and 13-14c, just behind the nose 64 and on the lower side of the knife 10, a tear drop shaped wire stripper opening 26 is formed by both housing halves. In all positions of the blade 16, including fully extended and fully retracted, the cutting edge of the blade 16 extends slightly into the opening 26, from the top wall of the opening 26. The top wall of the opening 26 is slotted to permit this. Thus, the cutting edge of the blade 16 can be used to cut the insulation of a wire placed laterally into the opening 26 and slid against the cutting edge. This process is illustrated in FIGS. 13-14c. Because the lower wall of the opening 26 tapers toward the cutting edge of the blade 16, wires of many different diameters can be stripped using the stripper opening 26. The wire is inserted into the large end of the opening, and moving the wire against the blade 16 causes the blade 16 to contact or nearly contact the metal of the wire. The knife is then rotated around the wire, or the wire is rotated relative to the knife, to create a cut through the plastic insulation all the way around the wire. With the blade 16 still engaged with the insulation, the wire can then be pulled out of the opening 26 to strip the insulation from the wire, or the wire can be removed from the opening 26 and the cut insulation simply pulled off of the wire by hand. Since the cutting edge of the blade 16 is used to cut the wire, and the blade 16 is replaceable, the stripper blade can be renewed when the cutting blade 16 is replaced.

Referring particularly to FIG. 7, the knife 10 includes a blade storage compartment 60 as mentioned above. The blade storage compartment 60 is also molded plastic and is preferably hinged at a lower rear corner to the housing 12 and has pins 106 at an upper side of the compartment that extend to the sides of the compartment and ride in arcuately-shaped slots that are formed in the housing halves 36 and 54. The slots 110 are arcuate, of generally a radius centered on the pivot point of the compartment, and at the upper end of the slots include détentes 112 that helps hold the compartment closed when it is closed so that the pins 106 are forced passed the détentes 112. The compartment 60 is therefore swung downwardly and rearwardly by grasping at handle 114, for example, with a fingernail, to gain access to the blades that are stored inside the compartment 60.

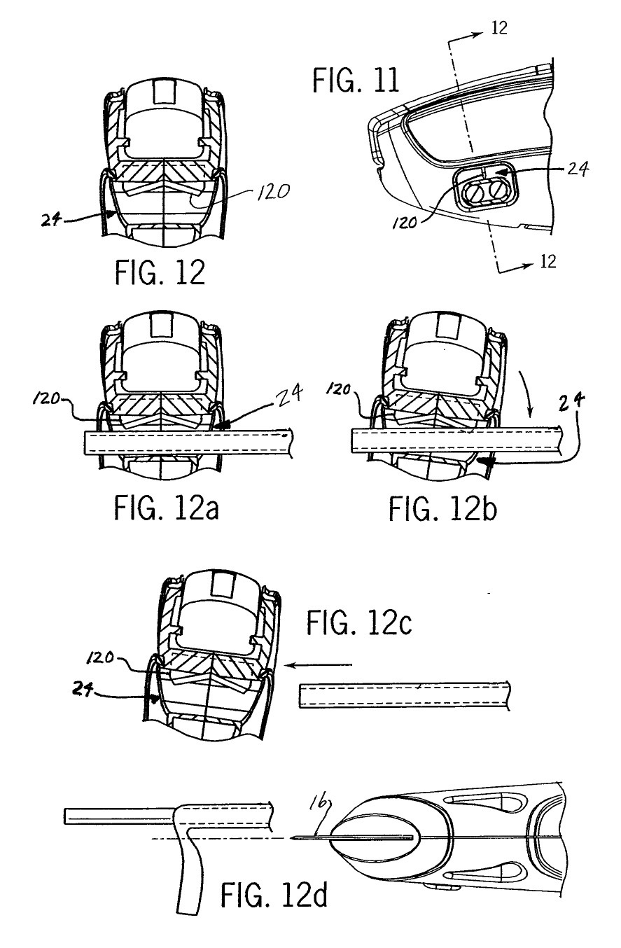

Referring to FIGS. 8, 10, and 11, the non-metallic sheathed electrical cable (NM) ripper 24 is formed in the rear lower portion of the knife 10 by the housing halves 36 and 54. The ripper 24 preferably has a longitudinal axis that is generally parallel to a transverse axis of the knife 10. An angled blade is molded into each housing half so that when the housing halves are put together, the two angled blades form a W-shaped angled blade 120 that extends from the top wall of the ripper opening 24 and is spaced apart from the bottom wall of the ripper opening 24. The angled blade 120 is preferably positioned in a middle third along the width direction of the opening 24. The width direction of the opening 24 should be understood to be a direction perpendicular to the direction in which the blade 120 extends from the top wall of the ripper opening 24. The middle third along the width direction should be understood to be the center segment of the opening 24 if the width of the opening 24 is divided into three equal segments. A piece of insulated cable, such as NM cable, as illustrated in FIG. 11, placed laterally through the opening 24 is positioned such that the space between the wires of the NM cable generally aligns with the blade 120. As illustrated in FIG. 12b, the knife can be tipped relative to the wire extending through the opening 24 to pierce the plastic jacket of the cable with one of the corners of the blade 120. Then, the knife can be moved relative to the wire or the wire can be pulled relative to the knife so that the corner of the blade 120 engaged with the plastic jacket of the cable slits the plastic jacket longitudinally. The plastic jacket is then peeled back from the wires formerly within the jacket as shown in FIG. 12d, and the blade 16 can be extended to cut off the excess peeled back jacket. From the above discussion, it should be appreciated that the ripping function of the knife 10 may be used both by right-handed and left-handed users.

As discussed above, the ripper 24 is suitable for creating a longitudinal slit in the jacket of an insulated wire, such as NM cable. A common type of NM cable is sold under the brand name Romex.

A utility knife of the invention is especially adapted for use during electrical work. Cutting, stripping, and ripping functions are combined in the knife, as well an optional live AC circuit detector. In addition, the knife has a plastic housing for being electrically insulated, but still has a heavy duty feel from the metal components used inside of the knife.

A preferred embodiment of the invention has been described in considerable detail. Many modifications and variations to the preferred embodiment described will be apparent to a person of ordinary skill in the art. Therefore, the invention should not be limited to the embodiment described.

I claim:

1. A hand tool having a cable jacket ripper, the ripper having an opening for receiving a cable extending axially there through in a housing of the tool, the opening having a blade presenting a cutting edge oriented axially in the opening on at least one side of the opening and positioned in the opening so that it can be brought into cutting contact with a jacket of the cable on one side of the cable to slit the jacket longitudinally and wherein the cable is non-round so rotating the cable against the opening engages the blade with the jacket to pierce the jacket.

2. A hand tool as in claim 1, wherein the blade is W-shaped to present a corner at each end of the blade so that either corner can be used to pierce and slit the jacket.

3. A hand tool as in claim 1, wherein the blade includes first and second blade sections, the first blade being positioned on a first section of the housing and the second blade being positioned on a second section of the housing.

4. A hand tool as in claim 1, wherein the hand tool is a utility knife.

5. A hand tool as in claim 4, wherein the opening is positioned at an end of the utility knife opposite a cutting blade.

6. A hand tool as in claim 4, wherein the utility knife further includes a non-contact voltage detector positioned at an end of the utility knife opposite a cutting blade.

7. A hand tool as in claim 6, wherein the non-contact voltage detector is received in a pocket in the housing such that an indicator of the non-contact voltage detector is positioned at the end of the utility knife opposite the cutting blade.

8. A hand tool as in claim 6, wherein the non-contact voltage detector is received in a pocket in the housing such that a sensor of the non-contact voltage detector is positioned at the end of the utility knife opposite the cutting blade.

9. A hand tool as in claim 6, wherein the non-contact voltage detector is received in a pocket in the housing such that a switch of the non-contact voltage detector is accessible by a user.

10. A hand tool as in claim 1, wherein the opening has a longitudinal axis that is generally parallel to a transverse axis of the hand tool.

11. A hand tool as in claim 1, wherein the opening has a width dimension, and the blade is positioned in a middle third of the width dimension.

12. A hand tool as in claim 1, wherein the blade pierces the jacket of the cable between two outer wires positioned within the cable.

13. A hand tool as in claim 1, wherein the hand tool also includes a non-contact voltage detector.

14. A utility knife having an extendable and retractable replaceable blade, the utility knife having two housing halves and at least one internal metal component fixed to at least one of the housing halves, the metal component providing at least half of the total weight of the utility knife.

15. A utility knife as in claim 14, wherein the metal component is a guide for a blade carrier of the knife.

16. A hand tool, comprising:
a housing having a handle portion;
an opening in the handle portion, the opening having a longitudinal axis and at least one blade, the at least one blade extending from a top wall of the opening and having a cutting edge spaced from a bottom wall of the opening;
wherein a cable inserted into the opening is pierced by rotating the utility hand tool in direction perpendicular to the longitudinal axis of the opening.

17. A hand tool as in claim 16, wherein the opening has a second blade, the first and second blades forming a W-shaped blade.

18. A hand tool as in claim 16, wherein the hand tool is a utility knife.

19. A hand tool as in claim 18, wherein the utility knife includes a carrier that has a cutting blade and an actuator button connected to the carrier that translates relative to the housing to extend and retract the cutting blade, the utility knife includes an internal component with a recess that defines a plurality of stop positions for the carrier and the cutting blade, and the internal component providing at least half of the total weight of the utility knife.

20. A hand tool as in claim 16, wherein the cutting edge of the at least one blade defines a direction that is angled relative to the longitudinal axis of the opening.
